(19) United States
(12) Patent Application Publication
(10) Pub. No.: US 2026/0074530 A1
(43) Pub. Date: Mar. 12, 2026

(54) MARINE STARTER BATTERY MANAGEMENT SYSTEM AND METHOD FOR MONITORING LOW-TEMPERATURE CHARGING AND DISCHARGING THEREOF

(71) Applicant: GUANGDONG GREENWAY TECHNOLOGY CO., LTD., DONGGUAN (CN)

(72) Inventors: ZHIWEI SHEN, DONGGUAN (CN); WEI WU, DONGGUAN (CN); XIANGLONG WU, DONGGUAN (CN); MIN QIN, DONGGUAN (CN); HAILIN YANG, DONGGUAN (CN); GUOHUA YE, DONGGUAN (CN)

(73) Assignee: GUANGDONG GREENWAY TECHNOLOGY CO., LTD., DONGGUAN (CN)

(21) Appl. No.: 19/325,516

(22) Filed: Sep. 11, 2025

(30) Foreign Application Priority Data
Sep. 11, 2024 (CN) 2024112734014
Mar. 28, 2025 (CN) 2025205850788
Apr. 7, 2025 (CN) 202520643118X
Jul. 29, 2025 (CN) 2025110564333

(51) Int. Cl. H02J 7/00; H01M 10/615; H01M 10/625; H01M 10/6571

(52) U.S. Cl. CPC H02J 7/40; H01M 10/615; H01M 10/625; H01M 10/6571; H02J 7/52; H02J 7/62; H02J 7/64; H02J 7/82; H02J 7/84; H02J 7/855; H02J 7/977; H02J 2105/31; H02J 2207/10

(57) ABSTRACT

The present disclosure provides a marine starter battery management system and a method for monitoring its low-temperature charging and discharging. The system comprises a battery management unit, a heating circuit, a high-current charge/discharge drive circuit, a passive balancing circuit, a voltage spike suppression circuit, a soft-start circuit, and a processing unit. The processing unit is electrically connected to these components. Based on battery state parameters, the processing unit controls in real-time the operating states and sequences of the heating circuit, the high-current drive circuit, the passive balancing circuit, the voltage spike suppression circuit, and the soft-start circuit. This intelligent, coordinated control of the various functional modules improves the safety, reliability, and performance of the marine starter battery, particularly in demanding low-temperature environments.

### TECHNICAL FIELD

The present disclosure relates to the field of marine battery technology, and more particularly, to a marine starter battery management system and a method for monitoring low-temperature charging and discharging of a marine starter battery.

### BACKGROUND

In the field of marine batteries, particularly for specific vessels such as ocean-going ships that travel through high-latitude regions, conventional marine starter batteries face challenges when providing starting power in low-temperature environments. Due to the properties of traditional battery electrolytes at low temperatures, issues arise such as insufficient starting current, a tendency for lithium plating during charging, and the premature triggering of overcharge protection, which can shut off the charging MOSFET.

To address the foregoing issues, existing battery systems in the prior art have employed heating elements. However, the heating methods provided by these solutions are extremely simplistic. Once a heating mode is activated, the heating element typically operates at its rated power output for an extended period. Although this can rapidly increase the battery's temperature, such an aggressive heating approach leads to problems like localized heat accumulation within the battery and excessive current draw by the heating elements. These issues adversely affect the operational safety and reliability of the vessel.

### SUMMARY

An object of the present disclosure is to overcome the deficiencies of the prior art by providing a marine starter battery management system and a method for monitoring low-temperature charging and discharging of a marine starter battery, which effectively improve the safety and reliability of charging and discharging operations in low-temperature environments.

The object of the present disclosure is achieved through the following technical solutions:

A marine starter battery management system, comprising:
a Battery Management Unit (BMU) configured to acquire battery state parameters of a battery unit, wherein the battery unit comprises a plurality of individual cells, and wherein the individual cells are marine starter battery cells;
a heating circuit configured to heat the battery unit in a low-temperature environment, wherein an output power of the heating circuit is between 50 W and 500 W;
a high-current charging and discharging drive circuit configured to drive the battery unit for high-current charging and discharging under low-temperature and low-voltage conditions;
a passive balancing circuit configured to dissipate energy from individual cells with higher voltages within the battery unit to balance the voltage of each individual cell, wherein the passive balancing circuit comprises a plurality of heating resistors, and wherein the heating resistors are heating film resistors;
a voltage spike suppression circuit configured to suppress voltage spikes at an end of a charging cycle, wherein the voltage spike suppression circuit comprises a plurality of clamping diodes;
a soft-start circuit configured to limit a current rise rate during the startup of the battery unit; and
a processing unit electrically connected to the BMU, the heating circuit, the high-current charging and discharging drive circuit, the passive balancing circuit, the voltage spike suppression circuit, and the soft-start circuit; wherein the processing unit is configured to, based on the battery state parameters, control in real-time the operating states and operating sequences of the heating circuit, the high-current charging and discharging drive circuit, the passive balancing circuit, the voltage spike suppression circuit, and the soft-start circuit.

A method for monitoring low-temperature charging and discharging of a marine starter battery, applied to the marine starter battery management system according to any one of the embodiments described above, the method comprising:
acquiring a charge and discharge temperature of the battery unit;
performing a likelihood loss process on the charge and discharge temperature and a preset battery temperature to obtain a charge and discharge temperature loss value;
determining whether the charge and discharge temperature loss value matches a preset temperature loss value; and
when the charge and discharge temperature loss value matches the preset temperature loss value, sending a low-temperature heating adjustment signal to a heating controller to adjust a power output mode of the heating circuit.

### BRIEF DESCRIPTION OF THE DRAWINGS

To provide a clearer understanding of the technical solutions in the embodiments of the present disclosure, the accompanying drawings used in the description of the embodiments are briefly introduced below. It should be understood that the following drawings illustrate only some embodiments of the present disclosure and should not be construed as limiting the scope thereof. For a person of ordinary skill in the art, other relevant drawings can be derived from these drawings without any inventive effort.

FIG. 1 is a flowchart of a method for monitoring low-temperature charging and discharging of a marine starter battery, according to an embodiment.

FIG. 2 is a system block diagram of a marine starter battery system, according to an embodiment.

FIG. 3 is a circuit diagram of a marine starter battery system, according to an embodiment.

FIG. 4 is a flowchart of a marine starter battery management method, according to an embodiment.

FIG. 5 is a circuit diagram of a short-circuit protection circuit, according to an embodiment.

FIG. 6 is an internal circuit diagram of the current detection chip U2 shown in FIG. 5.

FIG. 7 is a circuit diagram of a short-circuit detection circuit, according to an embodiment.

FIG. 8 is a topological circuit diagram of a passive balancing circuit, according to an embodiment.

FIG. 9 is a circuit diagram of a charging protection circuit, according to an embodiment.

FIG. 10 is a circuit system block diagram corresponding to the charging protection circuit, according to an embodiment.

### DETAILED DESCRIPTION

To facilitate a comprehensive understanding of the present disclosure, a more complete description will now be provided with reference to the accompanying drawings. Preferred embodiments of the disclosure are shown in the drawings. However, the present disclosure may be embodied in many different forms and should not be construed as limited to the embodiments set forth herein. Rather, these embodiments are provided so that this disclosure will be thorough and complete.

It is to be noted that when an element is referred to as being “fixed to” another element, it can be directly on the other element or intervening elements may also be present. When an element is considered to be “connected” to another element, it can be directly connected to the other element or intervening elements may also be present. The terms “vertical,” “horizontal,” “left,” “right,” and similar expressions used herein are for illustrative purposes only and do not imply a unique embodiment.

Unless otherwise defined, all technical and scientific terms used herein have the same meaning as commonly understood by one of ordinary skill in the art to which this disclosure belongs. The terminology used in the specification of the present disclosure is for the purpose of describing particular embodiments only and is not intended to be limiting of the disclosure. The term “and/or” as used herein includes any and all combinations of one or more of the associated listed items.

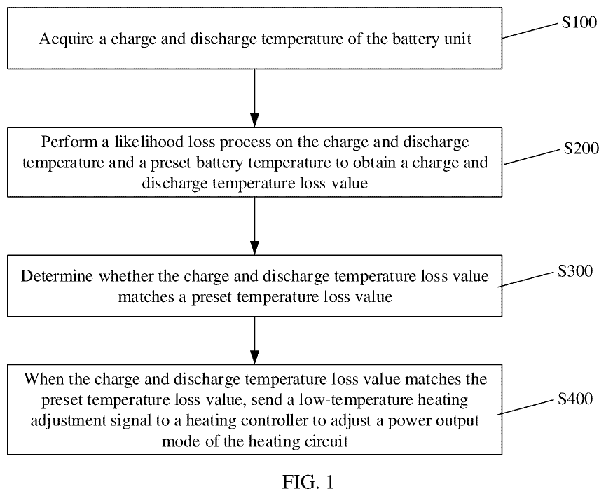

Reference is now made to FIG. 1, which is a flowchart of a method for monitoring low-temperature charging and discharging of a marine starter battery according to an embodiment of the present disclosure. The marine starter battery management system is used for managing the charging and discharging of a marine starter battery in a low-temperature environment. The marine starter battery management system comprises:
a Battery Management Unit (BMU) configured to acquire battery state parameters of a battery unit, wherein the battery unit comprises a plurality of individual cells, and wherein the individual cells are marine starter battery cells;
a heating circuit configured to heat the battery unit in a low-temperature environment, wherein an output power of the heating circuit is between 50 W and 500 W;
a high-current charging and discharging drive circuit configured to drive the battery unit for high-current charging and discharging under low-temperature and low-voltage conditions;
a passive balancing circuit configured to dissipate energy from individual cells with higher voltages within the battery unit to balance the voltage of each individual cell, wherein the passive balancing circuit comprises a plurality of heating resistors, and wherein the heating resistors are heating film resistors;
a voltage spike suppression circuit configured to suppress voltage spikes at an end of a charging cycle, wherein the voltage spike suppression circuit comprises a plurality of clamping diodes;
a soft-start circuit configured to limit a current rise rate during the startup of the battery unit; and
a processing unit electrically connected to the BMU, the heating circuit, the high-current charging and discharging drive circuit, the passive balancing circuit, the voltage spike suppression circuit, and the soft-start circuit; wherein the processing unit is configured to, based on the battery state parameters, control in real-time the operating states and operating sequences of the heating circuit, the high-current charging and discharging drive circuit, the passive balancing circuit, the voltage spike suppression circuit, and the soft-start circuit.

Further, the low-temperature battery charging monitoring method includes some or all of the following steps:

S100: Acquire a charge and discharge temperature of the battery unit.

In this embodiment, the charge and discharge temperature is the real-time temperature of the battery unit. That is, the charge and discharge temperature is the real-time charge/discharge temperature experienced by the individual marine starter battery cells within the battery unit, thereby corresponding to the charge/discharge temperature of the marine starter battery. Acquiring the charge and discharge temperature facilitates the determination of the real-time charge/discharge temperature conditions of the individual cells, and thus facilitates determining the real-time charge/discharge temperature conditions of the marine starter battery. The battery unit comprises a plurality of individual cells; that is, the battery unit is a battery pack, and the individual cells are marine starter battery cells.

S200: Perform a likelihood loss process on the charge and discharge temperature and a preset battery temperature to obtain a charge and discharge temperature loss value.

In this embodiment, the preset battery temperature is a standard battery temperature for the battery unit, i.e., a designated charge/discharge temperature for the individual marine starter battery cells, which corresponds to a safe charge/discharge temperature for the marine starter battery. Specifically, the preset battery temperature is between 8° C. and 10° C. By performing the likelihood loss process on the charge and discharge temperature and the preset battery temperature—specifically, by calculating the minimized negative log-likelihood loss between the charge and discharge temperature and the preset battery temperature—it is possible to determine the real-time temperature deviation of the individual cells, thereby determining whether the individual cells are in a low-temperature environment.

S300: Determine whether the charge and discharge temperature loss value matches a preset temperature loss value.

In this embodiment, the charge and discharge temperature loss value is obtained based on the charge and discharge temperature and the preset battery temperature, and is used to reflect the temperature level of the marine starter battery. The preset temperature loss value represents a standard charge/discharge temperature deviation. By comparing the charge and discharge temperature loss value with the preset temperature loss value, the degree of temperature difference can be determined, which facilitates the assessment of the environmental conditions of the marine starter battery.

S400: When the charge and discharge temperature loss value matches the preset temperature loss value, send a low-temperature heating adjustment signal to a heating controller to adjust a power output mode of the heating circuit.

In this embodiment, a match between the charge and discharge temperature loss value and the preset temperature loss value indicates that the charge/discharge temperature corresponds to a low-temperature condition defined by the preset temperature loss value. At this point, the battery is in a low-temperature environment. A low-temperature heating adjustment signal is sent to the heating controller-specifically, the processing unit sends a control signal to the heating controller-which then adjusts the heating power of the heating circuit. This allows the power output mode of the heating circuit to be adapted to the current low-temperature environment of the battery. This facilitates adjusting the battery's temperature to a safe range, thereby preventing issues such as insufficient starting current, lithium plating during charging, premature triggering of overcharge protection, and shutting off of the charging MOS. This also enables adaptive regulation of the battery unit's temperature, effectively improving the safety and reliability of charging and discharging for the marine starter battery in low-temperature environments.

In one embodiment, the step of determining whether the charge and discharge temperature loss value matches the preset temperature loss value comprises: determining whether the charge and discharge temperature loss value is less than a first temperature loss value and greater than a second temperature loss value. Here, the preset battery temperature is a temperature range between a first preset temperature and a second preset temperature. The first temperature loss value corresponds to the first preset temperature, and the second temperature loss value corresponds to the second preset temperature, wherein the first preset temperature is greater than the second preset temperature. In this embodiment, the preset battery temperature is a temperature range, where the first preset temperature is the upper limit and the second preset temperature is the lower limit. The minimized negative log-likelihood loss between the charge and discharge temperature and the first preset temperature is the first temperature loss value, which represents the degree of difference from the upper limit of the low-temperature range. The minimized negative log-likelihood loss between the charge and discharge temperature and the second preset temperature is the second temperature loss value, which represents the degree of difference from the lower limit of the low-temperature range. Thus, by evaluating the charge and discharge temperature loss value relative to the first and second temperature loss values, it can be determined whether the battery is in a low-temperature environment that requires heating.

Further, the step of sending a low-temperature heating adjustment signal comprises: when the charge and discharge temperature loss value is less than the first temperature loss value and greater than the second temperature loss value, sending a low-temperature heating enable signal to the heating controller to activate the heating circuit. In this embodiment, this condition indicates that the battery is in a low-temperature environment and requires heating to reach a safe charge/discharge temperature. Sending the low-temperature heating enable signal activates the heating circuit, allowing the battery's temperature to rise to a safe level in a timely manner and avoiding charging or discharging while in a low-temperature state.

Still further, the step of sending a low-temperature heating enable signal comprises: when the charge and discharge temperature loss value is less than the first temperature loss value and greater than the second temperature loss value, determining whether the charge and discharge temperature loss value is less than a critical temperature loss value. The critical temperature loss value corresponds to a third preset temperature, wherein the third preset temperature is less than the first preset temperature and greater than the second preset temperature. When the charge and discharge temperature loss value is less than the critical temperature loss value, a low-temperature full-power output signal is sent to the heating controller to cause the heating circuit to operate at its full power output. In this embodiment, the third preset temperature corresponding to the critical temperature loss value is an intermediate temperature. For example, the first preset temperature may be 8° C., the second preset temperature may be −20° C., and the third preset temperature may be 0° C. If the charge and discharge temperature loss value is less than the critical temperature loss value, it indicates the battery's temperature is below the critical temperature (e.g., sub-zero), signifying a particularly harsh low-temperature environment. Sending the low-temperature full-power output signal causes the heating circuit to operate at full power for rapid heating, thereby ensuring safer and more reliable battery operation.

In one embodiment, after sending the low-temperature full-power output signal, the method further comprises:
acquiring a battery pack discharge voltage of the battery unit;
determining whether the battery pack discharge voltage is greater than a first preset discharge voltage; and
when the battery pack discharge voltage is greater than the first preset discharge voltage, sending a level-one discharge clamping signal to a spike suppression controller to cause N1 clamping diodes in the voltage spike suppression circuit to be enabled, wherein N1 is a positive integer and N1<10.

In this embodiment, the battery pack discharge voltage is the real-time voltage during discharge. The first preset discharge voltage is a level-one standard discharge voltage, corresponding to a level-one safe discharge voltage for the specific low-temperature condition. If the battery pack discharge voltage is greater than the first preset discharge voltage, it indicates a relatively high voltage state even in the sub-zero environment. The level-one discharge clamping signal enables N1 clamping diodes, which prepares the circuit to absorb voltage spikes during a subsequent charging cycle, thereby preventing overvoltage damage to other electrical equipment when charge protection is later triggered.

Further, after determining whether the battery pack discharge voltage is greater than the first preset discharge voltage, the method further comprises:
when the battery pack discharge voltage is less than or equal to the first preset discharge voltage, determining whether the battery pack discharge voltage is greater than a second preset discharge voltage, wherein the second preset discharge voltage is less than the first preset discharge voltage; and
when the battery pack discharge voltage is greater than the second preset discharge voltage, sending a level-two discharge clamping signal to the spike suppression controller to cause N2 clamping diodes to be enabled, wherein N2 is a positive integer and N1<N2<10.

In this embodiment, the second preset discharge voltage is a level-two standard discharge voltage. This condition indicates the discharge voltage is between the level-one and level-two thresholds. The level-two discharge clamping signal enables N2 clamping diodes. By enabling more diodes (N2>N1), the circuit is prepared to absorb larger voltage spikes during a subsequent charge protection event.

Still further, after determining whether the battery pack discharge voltage is greater than the second preset discharge voltage, the method further comprises:
when the battery pack discharge voltage is less than or equal to the second preset discharge voltage, determining whether the battery pack discharge voltage is greater than a third preset discharge voltage, wherein the third preset discharge voltage is less than the second preset discharge voltage; and
when the battery pack discharge voltage is greater than the third preset discharge voltage, sending a level-three discharge clamping signal to the spike suppression controller to cause N3 clamping diodes to be enabled, wherein N3 is a positive integer and N2<N3<10.

In this embodiment, the third preset discharge voltage is a level-three standard discharge voltage. This condition indicates the discharge voltage is between the level-two and level-three thresholds. The level-three discharge clamping signal enables N3 clamping diodes, preparing the circuit to suppress even higher voltage spikes by activating the largest number of diodes in this tiered protection scheme.

In another embodiment, after determining whether the battery pack discharge voltage is greater than the third preset discharge voltage, the method further comprises:
when the battery pack discharge voltage is less than or equal to the third preset discharge voltage, sending a fourth-level discharge clamping signal to the spike suppression controller to cause N4 clamping diodes in the voltage spike suppression circuit to be enabled, wherein N4 is a positive integer and N3<N4<10.

In this embodiment, the battery pack discharge voltage being less than or equal to the third preset discharge voltage indicates that the discharge voltage is below the level-three threshold in the sub-zero environment. At this point, the fourth-level discharge clamping signal is sent to enable N4 clamping diodes. By enabling the largest number of diodes (N4), the circuit is prepared to absorb and suppress the highest potential voltage spikes during a subsequent charge protection event, thus preventing overvoltage damage to other electrical equipment.

In another embodiment, the first preset discharge voltage is 13.95V, the second preset discharge voltage is 13.5V, and the third preset discharge voltage is 12.9V.

In another embodiment, N1=2, N2=3, N3=4, and N4=5.

In one embodiment, after determining whether the charge and discharge temperature loss value is less than the critical temperature loss value, the method further comprises:
when the charge and discharge temperature loss value is greater than or equal to the critical temperature loss value, sending a low-temperature reduced-power output signal to the heating controller to cause the heating circuit to operate at a low-power output.

In this embodiment, this condition indicates that the battery's temperature is in a low-temperature range but above the critical temperature (e.g., above 0° C.), signifying a milder low-temperature environment. Sending the low-temperature reduced-power output signal causes the heating circuit to operate at a low power, resulting in a more gradual temperature increase. Specifically, the heating rate at low-power output is less than the heating rate at full-power output. The low power is less than the full power and, for example, greater than 30% of the full power. This prevents the heating circuit from operating at high power for extended periods, thereby prolonging its service life. Furthermore, this provides a more intelligent heating method, achieving dynamic control of the battery's temperature and making the charging and discharging of the marine starter battery safer and more reliable.

In one embodiment, after sending the low-temperature full-power output signal when the charge and discharge temperature loss value is less than the critical temperature loss value, the method further comprises:
acquiring a battery pack charging voltage of the battery unit;
determining whether the battery pack charging voltage is greater than a first preset charging voltage; and
when the battery pack charging voltage is greater than the first preset charging voltage, sending a level-one charging clamping signal to the spike suppression controller to cause M1 clamping diodes to be enabled, wherein M1 is a positive integer and M1<10.

In this embodiment, the battery pack charging voltage is the real-time voltage during the charging process. The first preset charging voltage corresponds to a level-one safe charging voltage. If the battery pack charging voltage exceeds this first preset level, it indicates a high voltage state. The level-one charging clamping signal enables M1 diodes to prepare the circuit to absorb voltage spikes that may occur, particularly when charge protection is triggered, which corresponds to a fully charged state of the battery.

Further, after determining whether the battery pack charging voltage is greater than the first preset charging voltage, the method further comprises:
when the battery pack charging voltage is less than or equal to the first preset charging voltage, determining whether the battery pack charging voltage is greater than a second preset charging voltage, wherein the second preset charging voltage is less than the first preset charging voltage; and
when the battery pack charging voltage is greater than the second preset charging voltage, sending a level-two charging clamping signal to the spike suppression controller to cause M2 clamping diodes to be enabled, wherein M2 is a positive integer and M1<M2<10.

This condition indicates the charging voltage is between the level-one and level-two thresholds. The level-two signal enables more diodes (M2) to prepare for absorbing a potentially higher voltage spike.

Still further, after determining whether the battery pack charging voltage is greater than the second preset charging voltage, the method further comprises:
when the battery pack charging voltage is less than or equal to the second preset charging voltage, determining whether the battery pack charging voltage is greater than a third preset charging voltage, wherein the third preset charging voltage is less than the second preset charging voltage; and
when the battery pack charging voltage is greater than the third preset charging voltage, sending a level-three charging clamping signal to the spike suppression controller to cause M3 clamping diodes to be enabled, wherein M3 is a positive integer and M2<M3<10.

This condition indicates the charging voltage is between the level-two and level-three thresholds, and the level-three signal enables even more diodes (M3) for greater spike suppression capability.

In another embodiment, after determining whether the battery pack charging voltage is greater than the third preset charging voltage, the method further comprises:
when the battery pack charging voltage is less than or equal to the third preset charging voltage, sending a fourth-level charging clamping signal to the spike suppression controller to cause M4 clamping diodes to be enabled, wherein M4 is a positive integer and M3<M4<10.

This condition handles the lowest voltage range by enabling the most diodes (M4) to prepare for the highest potential voltage spikes.

In another embodiment, the first preset charging voltage is 13.95V, the second preset charging voltage is 13.35V, and the third preset charging voltage is 12.75V.

In another embodiment, M1=2, M2=3, M3=4, and M4=5.

In another embodiment, in the case where the charge and discharge temperature loss value is greater than or equal to the critical temperature loss value (i.e., the milder low-temperature condition), the voltage spike issue may still be present. For voltage spikes in this situation, the clamping diodes of the voltage spike suppression circuit are controlled using the same method as described above. The battery pack discharge voltage and charging voltage are likewise acquired and compared against the same preset discharge and charging voltages mentioned previously, the details of which will not be reiterated herein.

In one embodiment, after acquiring the battery pack charging voltage of the battery unit, the method further comprises:
determining whether the battery pack charging voltage is greater than or equal to an overvoltage threshold; and
when the battery pack charging voltage is greater than or equal to the overvoltage threshold, sending a full-charge spike absorption signal to the spike suppression controller to cause the clamping diodes corresponding to the level-one charging clamping signal to be enabled for a preset spike absorption time.

In this embodiment, the overvoltage threshold is the upper limit of the charging voltage and corresponds to the voltage of the battery unit after being fully charged; that is, it is the overcharge voltage and is equal to the voltage at which the battery's charging MOS transistor turns off. When the charging voltage reaches this threshold, the charging MOS transistor transitions from a conducting state to a non-conducting state, which can cause a significant voltage spike. The full-charge spike absorption signal enables the M1 clamping diodes for the preset spike absorption time (for example, 90 milliseconds to 200 milliseconds, with an optimal time of 100 milliseconds) to absorb this specific spike.

In one embodiment, after sending the low-temperature full-power output signal when the charge and discharge temperature loss value is less than the critical temperature loss value, the method further comprises:
acquiring a maximum individual cell voltage difference within the battery unit;
determining whether the maximum individual cell voltage difference is less than or equal to a preset voltage difference; and
when the maximum individual cell voltage difference is less than or equal to the preset voltage difference, sending a first balancing-off signal to a balancing controller.

In this embodiment, the maximum individual cell voltage difference is the largest voltage gap between any two individual cells. The preset voltage difference is a safe tolerance (e.g., 50 mV). If the difference is within this tolerance, it indicates the cells are well-balanced, and balancing is not required.

Further, after determining whether the maximum individual cell voltage difference is less than or equal to the preset voltage difference, the method further comprises:
when the maximum individual cell voltage difference is greater than the preset voltage difference, acquiring a highest individual cell voltage within the battery unit;
determining whether the highest individual cell voltage is less than or equal to a preset individual cell voltage; and
when the highest individual cell voltage is less than or equal to the preset individual cell voltage, sending a second balancing-off signal to the balancing controller.

In this embodiment, even if the cells are imbalanced, balancing is not initiated if the voltage of the highest cell is still below a safe upper limit (e.g., 3.55V), indicating no immediate overvoltage risk.

Still further, after determining whether the highest individual cell voltage is less than or equal to the preset individual cell voltage, the method further comprises:
when the highest individual cell voltage is greater than the preset individual cell voltage, acquiring a highest cell core temperature within the battery unit;
determining whether the highest cell core temperature is greater than or equal to a preset cell core temperature; and
when the highest cell core temperature is greater than or equal to the preset cell core temperature, sending a third balancing-off signal to the balancing controller.

In this embodiment, the preset cell core temperature is the maximum safe operating temperature (e.g., 50° C.). If the highest cell voltage exceeds its threshold, but the cell core is also overheating, balancing is disabled. This is because passive balancing generates heat and performing it on an already hot cell would exacerbate the over-temperature condition.

In another embodiment, after determining whether the highest cell core temperature is greater than or equal to the preset cell core temperature, the method further comprises:
when the highest cell core temperature is less than the preset cell core temperature, sending a balancing-enable signal to the balancing controller.

In this embodiment, the conditions are met where the maximum individual cell voltage difference is greater than the preset voltage difference, the highest individual cell voltage is greater than the preset individual cell voltage, and the highest cell core temperature is less than the preset cell core temperature. This signifies a state where the marine starter battery has a large cell voltage disparity and a cell in an overvoltage condition, but without an over-temperature risk. At this point, the balancing-enable signal is sent to the balancing controller to initiate energy balancing via the passive balancing circuit, thereby ensuring that the battery unit does not trigger overcharge protection.

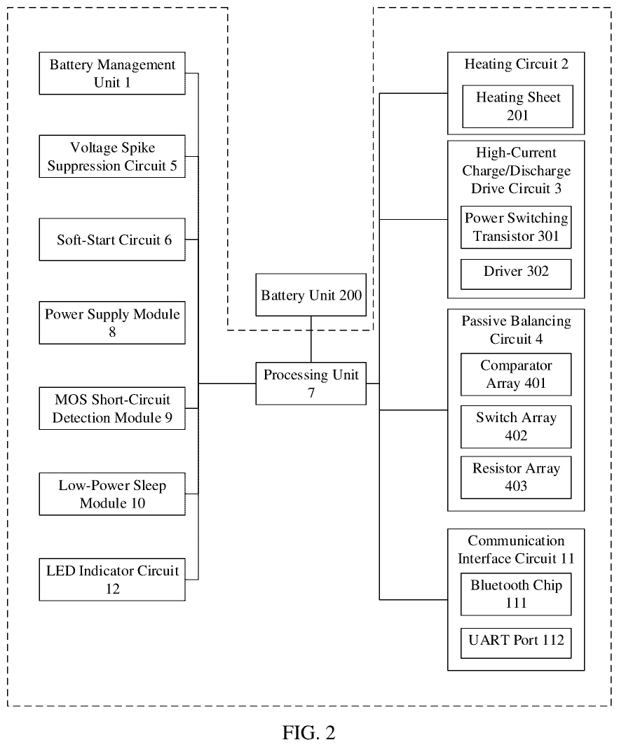

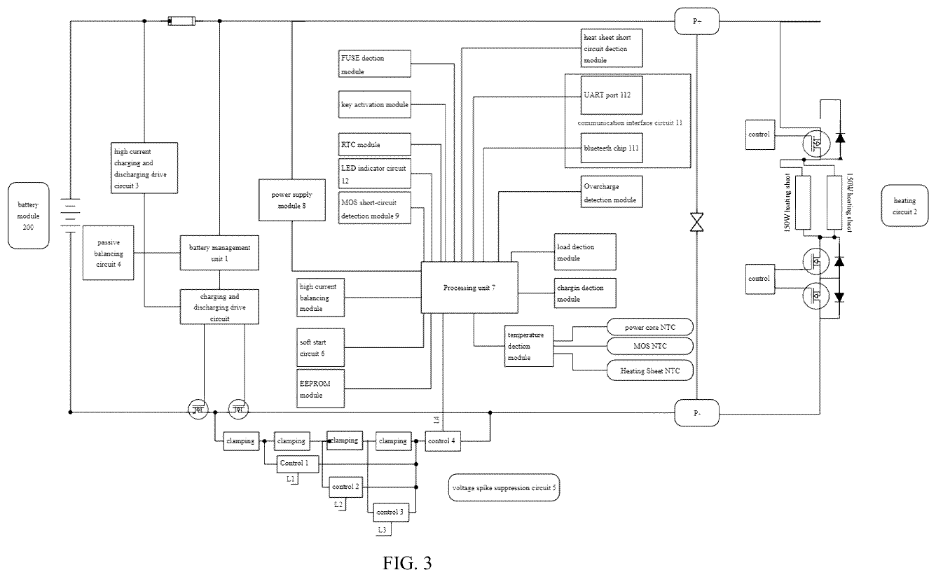

Referring to FIG. 2 and FIG. 3, a marine starter battery system 1000 according to this embodiment includes a battery unit 200 and a marine starter battery management system 100, wherein the marine starter battery management system 100 is electrically connected to the battery unit 200. The marine starter battery management system 100 comprises a battery management unit 1, a heating circuit 2, a high-current charging and discharging drive circuit 3, a passive balancing circuit 4, a voltage spike suppression circuit 5, a soft-start circuit 6, and a processing unit 7. The constituent parts of the marine starter battery management system 100 will be described in detail below.

The battery management unit 1 is primarily responsible for the comprehensive management and control of the battery unit 200. Its responsibilities include, on one hand, the real-time monitoring of the battery state parameters of the battery unit 200, and on the other hand, control and management functions such as balancing control, charge and discharge management, and fault diagnosis, all to ensure the safe, stable, and efficient operation of the battery unit 200. The battery state parameters herein include, but are not limited to, voltage parameters, current parameters, temperature parameters, State of Charge (SOC) parameters, and State of Health (SOH) parameters.

The battery management unit 1 has an interface for electrical connection to the battery unit 200, which comprises a plurality of individual cells. The battery unit 200 herein is generally a lithium-ion battery, serving as the energy storage center for the entire marine starter battery system. The battery unit 200 is composed of individual cells with high energy density and excellent high-rate discharge performance to provide the required electrical energy for the ship's starting equipment and other electrical loads.

It is to be understood that, as the core monitoring module of the entire system, the battery management unit 1 undertakes the dual responsibilities of battery state awareness and safety management. The battery management unit 1 must not only grasp the real-time operating state of the battery but also ensure its safe and reliable operation in the complex marine environment. The battery management unit 1 herein may be a commercially available BMS unit, in which case it can further acquire more than twenty battery state parameters, such as voltage, current, temperature, SOC, and SOH, to allow the processing unit 7 to perform more detailed coordination and management of the battery unit 200.

Considering that ships often navigate in various harsh climatic conditions, and particularly the problem of significant performance degradation of lithium batteries in cold sea regions, this embodiment integrates a dedicated heating circuit 2. Unlike the limited-power heating films found in traditional battery systems, the heating circuit 2 of this embodiment employs a high-power heating module. The heating power can be a fixed value or adjustable. When the high-power heating module has a fixed heating power, its power is preferably 300 W. When the heating power is adjustable, its adjustment range is 50 W-500 W, preferably 200 W-500 W, with a more preferred initial set value of 300 W.

Specifically, the heating circuit 2 includes at least one heating sheet 201 (FIG. 3 shows two by way of example), which is attached to or positioned adjacent to the battery unit 200. When the ambient temperature is too low, the heating circuit 2 activates to provide heat to the battery unit 200, raising its temperature to ensure it maintains good performance, extending its service life, and improving the startup reliability of the vessel in cold regions.

A ship's starting system has extremely high requirements for current output capability, a challenge that is more severe under low-temperature conditions. Therefore, this embodiment integrates a dedicated high-current charging and discharging drive circuit 3 to drive the battery unit for high-current charging and discharging under low-temperature and low-voltage conditions, thereby stably driving the high-current charge and discharge process in harsh environments. Specifically, during its operation, the high-current charging and discharging drive circuit 3 adopts corresponding heating schemes based on different temperature ranges. For instance, in an extremely low-temperature environment, the system activates the aforementioned high-power heating circuit 2 for rapid heating. In less cold conditions, the system may selectively enable a relatively low-power heating film, such as a 20 W heating film, for precise temperature control. Employing different heating schemes for different temperature ranges ensures both rapid response capability in severe cold and energy-efficient operation in general low-temperature environments.

During the charging phase, the high-current charging and discharging drive circuit 3, based on the temperature monitoring results from the battery management unit 1, selects an appropriate heating method to raise the battery temperature into a safe charging range, ensuring the safety and efficiency of the charging process while effectively preventing potential damage from overcharging and low-temperature charging.

During the discharging phase, the high-current charging and discharging drive circuit 3, through precise current control algorithms, can stably output a large current even in a low-temperature environment, preventing over-discharge and ensuring the normal operation of the ship's starting equipment and other critical electrical loads.

It is noteworthy that this embodiment can either utilize a single high-power heating device to handle various low-temperature scenarios for integrated temperature management, or it can be configured with separate high-power heating circuits 2 and low-power heating films for differentiated handling based on different temperature levels, thereby optimizing energy consumption while ensuring performance.

Specifically, the high-current charging and discharging drive circuit 3 includes a power switching transistor 301 and a driver 302. The rated current of the power switching transistor 301 is not less than 80 A, and is preferably 100 A, and it is used to control the connection and disconnection of the main power circuit, which is the current path between the battery unit 200 and the load. The driver 302 is electrically connected to the processing unit 7 and the power switching transistor 301 and is used to drive the power switching transistor 301. The processing unit 7 controls the operating state of the driver 302 based on the temperature and voltage parameters of the battery unit 200.

Due to variations in manufacturing processes and operating environments, performance differences among the individual cells in the battery unit 200 are inevitable. Such inconsistencies can severely affect the overall battery performance and lifespan. To address this key issue, this embodiment integrates a passive balancing circuit 4, which is used to dissipate energy from the individual cells with higher voltages to equalize the voltage of each individual cell. The passive balancing circuit 4 monitors the voltage of each cell in real-time. When a voltage difference is detected, it uses heating resistors to dissipate the excess energy from the higher-voltage cells, causing the voltages of all cells in the battery unit 200 to converge, thereby ensuring the overall performance and lifespan of the battery unit 200 and improving system reliability. It is understood that in other embodiments, active balancing methods may also be employed to ensure cell consistency, the details of which are not elaborated here.

The balancing current of the passive balancing circuit 4 is between 0.5 A-10 A, preferably 3 A-10 A, and more preferably 5 A. The power of the heating resistors is between 3 W-30 W, preferably 15 W-30 W, and more preferably 20 W, to perform high-current passive balancing and ensure voltage consistency among the cells in a relatively short time. Specifically, the passive balancing circuit 4 includes a comparator array 401, a switch array 402, and a resistor array 403. The comparator array 401 is electrically connected to each respective individual cell and is used to compare their voltages. The switch array 402 is electrically connected to the comparator array 401 and is used to select the cells that require balancing. The resistor array 403 is selectively connected in parallel with an individual cell via the switch array 402 to dissipate the energy of the cell requiring balancing (i.e., the high-voltage cell).

To prevent voltage spikes during the charging process from threatening the safety of onboard electronic equipment, especially the dangerous voltage transients that can occur near the end of the charge cycle when the charging state is about to change, this embodiment integrates a dedicated voltage spike suppression circuit 5. During the process of turning off the charging transistor when the battery is fully charged, the voltage spike suppression circuit 5, through its clamping diodes, can rapidly clamp the spike voltage within a safe range by absorbing the excess electrical energy. Experimental measurements show that controlling the spike voltage to a fluctuation range of 15%-20% of the rated voltage of the ship's electrical equipment can effectively prevent damage to said equipment, thus protecting the reliability and safety of the ship's systems. In this embodiment, the clamping voltage of the clamping diodes is 110%-125% of the rated voltage of the battery unit 200, and is preferably 115%-120%.

It can be understood that the large inrush current at the moment of startup can not only damage the battery itself but may also affect the stability of the ship's electrical system. To achieve a smooth power transfer, this embodiment integrates a soft-start circuit 6 to limit the current rise rate during the startup of the battery unit. The soft-start circuit 6 is connected in series in the battery output circuit. When the battery unit 200 starts up, the soft-start circuit 6 can smoothly control the rise of the charge and discharge current, avoiding excessive inrush current that could damage the battery unit 200 and the ship's electrical system. This effectively protects the equipment, extends the service life of the battery and the electrical system, and improves the stability and reliability of the ship's electrical system.

The aforementioned functional modules need to work in an orderly manner under the unified coordination of the processing unit 7 to achieve their optimal effect. The processing unit 7 processes data from various sensors and modules and issues corresponding control commands to coordinate the work of each module, thereby achieving precise scheduling and management of the entire system. The processing unit 7 is electrically connected to the battery management unit 1, the heating circuit 2, the high-current charging and discharging drive circuit 3, the passive balancing circuit 4, the voltage spike suppression circuit 5, and the soft-start circuit 6. The processing unit 7 controls the operating states and timing sequences of these modules in real-time based on the battery state parameters. The processing unit 7 herein is a microcontroller (MCU) into which a specific control program is written to perform precise scheduling and coordinated management of the entire system.

Specifically:

When the temperature parameter of the battery unit 200 is below a first preset threshold, the processing unit 7 controls the heating circuit 2 to activate and pauses high-current charge/discharge operations.

When the voltage difference between individual cells is detected to exceed a second preset threshold, the processing unit 7 initiates passive balancing control.

When the charging current drops to a third preset threshold, the processing unit 7 initiates voltage spike suppression control.

Further, the marine starter battery management system 100 of this embodiment also includes a power supply module 8, a MOS short-circuit detection module 9, and a low-power sleep module. The processing unit 7 is also electrically connected to these modules. The power supply module 8 provides operating power to the various modules of the system. The MOS short-circuit detection module 9 is used to detect a short-circuit state of the power switching transistor 301 in the main power circuit. The low-power sleep module is used to place the system into a sleep state to reduce static power consumption when the battery unit 200 is not in use for an extended period.

Further, the marine starter battery management system 100 of this embodiment also includes a communication interface circuit 11 and a display module, wherein the display module is an LED indicator circuit 12 or an LCD display circuit. The processing unit 7 is also electrically connected to the communication interface circuit 11 and the LED indicator circuit 12. The communication interface circuit 11 includes a Bluetooth chip 111 and a communication module, which may be a UART (Universal Asynchronous Receiver/Transmitter) port 112, RS485, or CAN bus, used to achieve both wireless and wired data transmission. The communication interface circuit 11, with its integrated Bluetooth and UART modules, allows for a connection between the battery and a mobile phone APP via Bluetooth. This can display in real-time more than 20 core parameters, such as battery voltage, current, remaining capacity, and cycle count, and also supports custom naming and group management for multiple battery units 200. The system provides an active diagnostic function; when an overcurrent, high temperature, or abnormal discharge is detected, an alert is immediately pushed to the mobile phone, helping the user to identify potential issues in advance and accurately monitor the battery's health status. Concurrently, the UART communication module can interact with other devices or systems for broader data transmission and control functions.

Specifically, the Bluetooth chip 111 is used for transmitting battery state parameters. The processing unit 7 sends diagnostic information and abnormal alert data to an external device via the Bluetooth chip 111. The battery state parameters herein include voltage parameters, current parameters, temperature parameters, SOC parameters, SOH parameters, cycle count, and the like.

The LED indicator circuit 12 is used for displaying the battery's operating status. The operating status, such as power level, charging state, and fault alarms, is intuitively displayed through an LED module. By using flashing patterns, the LED indicators allow a user to understand the battery's operational status in real-time and take corresponding measures in a timely manner.

In another embodiment, the LED indicator circuit can also be used for an LCD screen display.

In another embodiment, the communication interface circuit can also be an RS485 or CAN bus.

FIG. 3 shows a specific circuit block diagram of the marine starter battery system of this embodiment. According to practical needs, it is additionally provided with a charge/discharge drive module, a charge/discharge control module, a temperature detection module, a load detection module, a charging detection module, and an abusive charging detection module. It should be noted that some of the modules provided in this embodiment may be sub-modules within the battery management unit 1 or may be modules independent of the battery management unit 1, which is not limited herein.

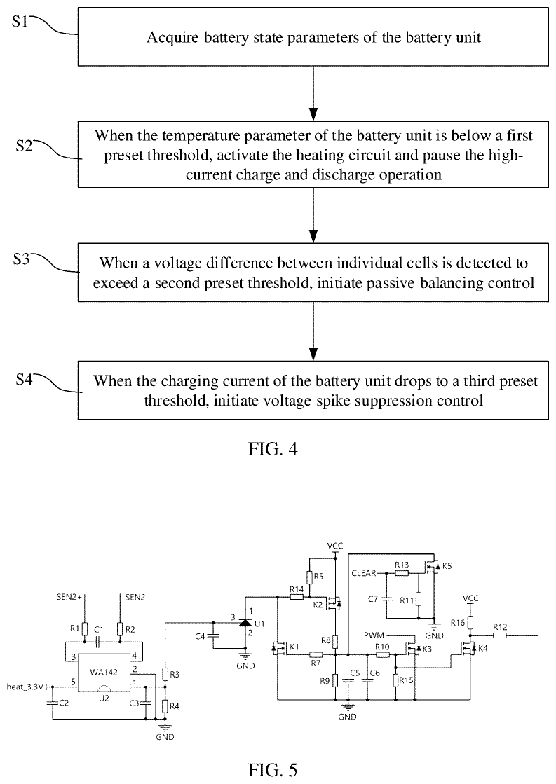

Referring to FIG. 2 through FIG. 4, a marine starter battery management method according to this embodiment is applied to the aforementioned marine starter battery management system 100. The method comprises the following steps:
S1: Acquire battery state parameters of the battery unit 200.
S2: When a temperature parameter of the battery unit 200 is below a first preset threshold, control the heating circuit 2 to activate and pause high-current charge and discharge operations.
S3: When a detected voltage difference between individual cells exceeds a second preset threshold, initiate passive balancing control.
S4: When a charging current of the battery unit 200 drops to a third preset threshold, initiate voltage spike suppression control. The third preset threshold is 10% of the rated charging current (adjustable within a range of 5%-15%, preferably 10%).

Preferably, the first preset threshold is −10° C. to 5° C.; the second preset threshold is 30 mV-100 mV; the third preset threshold is 5%-15% of the rated charging current; and the battery state parameters include voltage parameters, current parameters, temperature parameters, SOC parameters, SOH parameters, and the like.

During the period when the heating circuit 2 is activated, the passive balancing control is stopped.

Further, the marine starter battery management method of this embodiment also comprises the following steps:

Displaying the operating status of the battery unit 200 via the LED indicator circuit 12 and pushing detected overcurrent, high-temperature, or abnormal discharge states to an external terminal via Bluetooth communication.

Predicting a remaining lifespan of the battery unit 200 based on its historical usage data and current state parameters, and outputting the prediction result to an external terminal via a communication interface.

Monitoring a short-circuit state of the power switching transistor 301 and, upon detecting a short circuit, disconnecting the main power circuit, which is the current path between the battery unit 200 and the load.

When a system idle time is detected to exceed a set value, controlling the system to enter a low-power mode.

In conjunction with FIG. 2 through FIG. 4, the present disclosure has the following beneficial effects:

On one hand, through the cooperation of the heating circuit 2 and the high-current charging and discharging drive circuit 3, the present disclosure solves the problem of limited performance of marine starter batteries in low-temperature environments, ensuring the battery can still output a large current to meet the ship's starting demands. On another hand, the voltage spike suppression circuit 5 effectively suppresses voltage spikes at the end of a charging cycle, protecting onboard electrical equipment from damage, while the soft-start circuit 6 limits the current rise rate during startup, preventing large inrush currents from damaging the battery and the ship's electrical system. Furthermore, the passive balancing circuit 4, with its high-current balancing design, can quickly balance the voltages of individual cells, maintaining the consistency of the battery unit 200 and extending its service life. In addition, under the unified scheduling of the processing unit 7, all functional modules work synergistically based on the state parameters collected by the battery management unit 1, achieving intelligent management of the battery unit 200 and significantly enhancing the environmental adaptability and operational reliability of the marine starter battery.

Referring to FIG. 5, FIG. 5 is a schematic structural diagram of a short-circuit protection circuit provided in an embodiment of the present disclosure. The marine starter battery management system further includes the short-circuit protection circuit, which is configured to immediately disconnect the battery discharge circuit when a short circuit occurs.

The short-circuit protection circuit specifically includes:

A short-circuit detection circuit configured to sample a voltage drop across a current sensing resistor in the battery discharge circuit. Specifically, the short-circuit detection circuit can, based on the sampled voltage drop, identify whether a short circuit has occurred and, when a short circuit occurs, the output terminal of the short-circuit detection circuit outputs a low-level signal.

A self-latching module electrically connected to the output of the short-circuit detection circuit, configured to, when a short circuit occurs, immediately cause a power control switching transistor to turn off or become non-conductive.

Specifically, the self-latching module includes a short-circuit signal latching unit having a switching transistor K1, a short-circuit response unit having a switching transistor K2, and a circuit turn-off unit having a switching transistor K3.

An output of the short-circuit response unit is electrically connected to an input of the circuit turn-off unit and an input of the short-circuit signal latching unit, respectively. An output of the circuit turn-off unit is electrically connected to a control terminal of the power control switching transistor. An output of the short-circuit signal latching unit is electrically connected to an input of the short-circuit response unit.

When the battery discharge circuit is operating normally, the switching transistors K1, K2, and K3 are all turned off or non-conductive.

When a short circuit occurs in the battery discharge circuit, a low-level signal is applied to the input of the short-circuit response unit, causing the switching transistor K2 to turn on. The output of the short-circuit response unit then outputs a high-level signal. Once a high-level signal is applied to the input of the short-circuit signal latching unit, the switching transistor K1 turns on, and the output of the short-circuit signal latching unit is pulled down to a low-level signal, which in turn locks the switching state of the switching transistor K2 in the “on” state. When a high-level signal is applied to the input of the circuit turn-off unit, the switching transistor K3 turns on, pulling the control terminal of the power control switching transistor down to a low-level signal, thereby causing the power control switching transistor to turn off or become non-conductive.

The aforementioned short-circuit protection circuit employs a hardware protection method that uses a combination of switching transistors to achieve signal self-latching. It has no delay and a fast response time, allowing it to quickly turn off the power control switching transistor when a short circuit occurs, thus preventing damage from thermal breakdown due to sustained overload. It also eliminates the need for a multi-channel operational amplifier circuit, effectively reducing costs.

Furthermore, the circuit includes an unlock function, providing more flexibility in handling various operating conditions after a short-circuit protection event is triggered. This particularly avoids the drawback of the load side being unusable after a false trigger, thereby increasing the user's fault tolerance.

Specifically, the self-latching module is also electrically connected to an unlock module. The unlock module can be controlled, after a short circuit has occurred, to pull the input of the short-circuit signal latching unit down to a low-level signal, causing the switching transistor K1 to turn off or become non-conductive.

More specifically, the unlock module includes a resistor R13, a capacitor C7, a resistor R11, and a switching transistor K5. A first end of the resistor R13 is electrically connected to an unlock signal output terminal of the battery's MCU and a positive terminal of the capacitor C7, respectively. The MCU's unlock signal output terminal is used to pull the input of the short-circuit signal latching unit down to a low-level signal. A second end of the resistor R13 is electrically connected to a first end of the resistor R11 and a control terminal of the switching transistor K5, respectively. A negative terminal of the capacitor C7 and a second end of the resistor R11 are connected to ground. A positive terminal of the switching transistor K5 is electrically connected to the output of the short-circuit response unit, and a negative terminal of the switching transistor K5 is connected to ground. The switching transistor K5 is an NMOS transistor or an NPN bipolar transistor.

In the short-circuit protection circuit provided by this embodiment, hardware is used for protection, and software is used to determine whether to recover. As shown in FIG. 5, when a short circuit occurs, the short-circuit response unit outputs a short-circuit signal (i.e., a high-level signal), causing the switching transistor K3 to turn on and shut off the power control switching transistor. Simultaneously, this short-circuit signal is also sent to the MCU via a short-circuit notification unit circuit. In this embodiment, after the short-circuit signal is received by the short-circuit notification unit circuit, the notification circuit sends a low-level signal to a short-circuit signal monitoring terminal of the MCU, informing the MCU that a short circuit has occurred.

Further, the MCU then determines if the conditions for releasing the short-circuit protection are met (i.e., the short circuit no longer exists, and the circuit can operate normally). Once the conditions are met, the MCU sends a clear signal to the switching transistor K5, causing the self-latching module to release the latch and begin a new round of detection.

Specifically, this embodiment uses a low-level signal to notify the MCU. The short-circuit notification unit circuit is implemented as follows: it includes a resistor R15, a switching transistor K4, a resistor R16, and a resistor R12. A first end of the resistor R15 is electrically connected to the control terminal of the switching transistor K3 and the control terminal of the switching transistor K4, respectively. A second end of the resistor R15 and a negative terminal of the switching transistor K4 are both connected to ground. A first end of the resistor R16 is connected to a working power supply VCC. A second end of the resistor R16 is electrically connected to a positive terminal of the switching transistor K4 and a first end of the resistor R12, respectively. A second end of the resistor R12 is electrically connected to the short-circuit signal monitoring terminal of the MCU. The switching transistor K4 is an NMOS transistor or an NPN bipolar transistor.

In the short-circuit protection circuit provided by this embodiment, an instantaneous short-circuit signal is captured and self-latched to achieve stable protection. The specific circuit implementation is as follows:

The short-circuit signal latching unit also includes a resistor R7. The short-circuit response unit also includes a resistor R5, a resistor R14, and a resistor R9. A first end of the resistor R14 is the input of the short-circuit response unit, and a first end of the resistor R9 is the output of the short-circuit response unit. The switching transistor K1 is an NMOS or NPN transistor, and the switching transistor K2 is a PMOS or PNP transistor.

The first end of the resistor R14 is electrically connected to a positive terminal of the switching transistor K1. A second end of the resistor R14 is electrically connected to a control terminal of the switching transistor K2. A positive terminal of the switching transistor K2 is connected to the working power supply VCC, and a negative terminal of the switching transistor K2 is connected to the first end of the resistor R9. A second end of the resistor R9 is connected to ground. A resistor R5 is also electrically connected between the positive terminal and the control terminal of the switching transistor K2.

A control terminal of the switching transistor K1 is electrically connected to a first end of the resistor R7. A second end of the resistor R7 is electrically connected to the first end of the resistor R9. A negative terminal of the switching transistor K1 is connected to ground.

The short-circuit response unit also includes a resistor R8 and a capacitor C5. A first end of the resistor R8 is electrically connected to the negative terminal of the switching transistor K2, and a second end of the resistor R8 is electrically connected to the first end of the resistor R9. A positive terminal of the capacitor C5 is electrically connected to the first end of the resistor R9, and a negative terminal of the capacitor C5 is connected to ground.

The circuit turn-off unit includes a capacitor C6, a resistor R10, and the switching transistor K3.

A first end of the resistor R10 is electrically connected to the first end of the resistor R9 and a positive terminal of the capacitor C6, respectively. A second end of the resistor R10 is electrically connected to the control terminal of the switching transistor K3. A positive terminal of the switching transistor K3 is electrically connected to the control terminal of the power control switching transistor. A negative terminal of the capacitor C6 and a negative terminal of the switching transistor K3 are both connected to ground. The switching transistor K3 is an NMOS transistor or an NPN bipolar transistor.

Specifically, the short-circuit detection circuit includes a current detection chip U2 configured to sample the voltage drop across the current sensing resistor and to amplify and output the sampled voltage drop according to a preset amplification factor. An output of the current detection chip U2 is electrically connected to a short-circuit identification unit circuit.

The short-circuit identification unit circuit includes a resistor R3, a resistor R4, a capacitor C4, and a programmable precision voltage reference U1. The output of the current detection chip U2 is electrically connected to a first end of the resistor R4. A second end of R4 is connected to ground. A first end of the resistor R3 is electrically connected to a positive terminal of the capacitor C4 and a reference terminal of the programmable precision voltage reference U1, respectively. A second end of the resistor R3 is electrically connected to the first end of the resistor R4. A positive terminal of the programmable precision voltage reference U1 is electrically connected to the input of the short-circuit response unit. A negative terminal of the programmable precision voltage reference U1 is connected to ground.

When a short circuit occurs, the voltage output by the current detection chip U2 is greater than or equal to a preset threshold voltage, causing the programmable precision voltage reference U1 to conduct, and a low-level signal is applied to the input of the short-circuit response unit.

By way of example, the programmable precision voltage reference U1 is a TL431 type voltage reference chip.

Assuming a 4 mΩ sensing resistor is used, when the current threshold for short-circuit protection reaches 31.25 A (calculated as 2.5V÷20 gain÷0.004Ω), the programmable precision voltage reference U1 conducts, its positive terminal (pin 1 in FIG. 5) is pulled low, and a low-level signal is applied to the input of the short-circuit response unit.

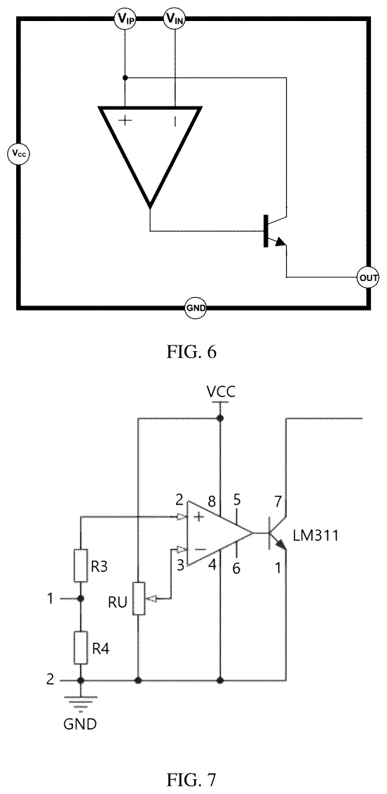

Specifically, referring to FIG. 6, FIG. 6 is a schematic of the internal circuit structure of the current detection chip U2 from FIG. 5. In this embodiment, the current detection chip U2 is a model WA142 provided by Wel-Bai company of Taiwan. The chip has a built-in differential amplifier and an NPN bipolar transistor.

A positive terminal of the sensing resistor is electrically connected to a first end of a resistor R1. A negative terminal of the sensing resistor is electrically connected to a first end of a resistor R2, where resistors R1 and R2 have the same resistance. A second end of the resistor R1 is electrically connected to a positive input terminal of the differential amplifier (pin 3 of U2 in FIG. 5) and a positive terminal of a capacitor C1, respectively. A second end of the resistor R2 is electrically connected to a negative input terminal of the differential amplifier (pin 4 of U2 in FIG. 5) and a negative terminal of the capacitor C1, respectively. An output of the differential amplifier is electrically connected to a base of the NPN transistor. A collector of the NPN transistor is electrically connected to the positive input terminal of the differential amplifier. An emitter of the NPN transistor is the output of the current detection chip U2 (pin 1 of U2 in FIG. 5). The output of the current detection chip U2 is also electrically connected to a positive terminal of a capacitor C3, and a negative terminal of the capacitor C3 is connected to ground.

For the wiring of the other pins of the current detection chip U2, please refer to FIG. 5. That is, pin 2 of the chip U2 is the GND pin, which is connected to ground. Pin 5 of the chip U2 is the VCC pin, which is connected to a +3.3V power supply, and a capacitor C2 is connected between the VCC pin and a low signal (ground).

The output voltage of the current detection chip U2=(resistance of R4/resistance of R2)*(voltage difference between the two input terminals of the differential amplifier). Therefore, based on the conduction condition of U1, the resistance ratio of R4 and R2 can be set accordingly to provide the required voltage to the reference terminal of U1 to cause U1 to conduct.

As an alternative embodiment, the short-circuit identification unit circuit can also be implemented with the following circuit structure:

Referring to FIG. 7, FIG. 7 is a schematic structural diagram of a short-circuit detection circuit provided in an embodiment of the present disclosure.

The short-circuit identification unit circuit includes a resistor R3, a resistor R4, a variable resistor RU, and a voltage comparator U1A. The voltage comparator U1A is an LM311 voltage comparator.

A first pin of the voltage comparator U1A is connected to ground. A second pin of the voltage comparator U1A is electrically connected to a first end of the resistor R3. A third pin of the voltage comparator U1A is electrically connected to a sliding adjustment terminal of the variable resistor RU. A fourth pin of the voltage comparator U1A is connected to ground. A seventh pin of the voltage comparator U1A is electrically connected to the input of the short-circuit response unit. An eighth pin of the voltage comparator U1A is electrically connected to the working power supply VCC of the short-circuit protection circuit. A second end of the resistor R3 is electrically connected to the output of the current detection chip U2 and a first end of the resistor R4, respectively. A second end of R4 is connected to ground. A first end of the variable resistor RU is connected to the working power supply VCC, and a second end of the variable resistor RU is connected to ground.

When a short circuit occurs in the battery discharge circuit, the voltage output by the current detection chip U2 is greater than or equal to a preset threshold voltage, and the seventh pin of the voltage comparator U1A outputs a low-level signal.

By way of example, the voltage output and amplified by the current detection chip U2 is applied to pin 2 of U1A. The voltage at pin 2 is compared with the voltage at pin 3. If the voltage at pin 2 is greater than the voltage at pin 3, a short-circuit signal is immediately output. Pin 3 is an adjustable voltage comparison point, and the voltage applied to pin 3 is adjusted via the variable resistor RU.

As shown in FIG. 7, if the short-circuit identification unit circuit is implemented using a voltage comparator, the response speed of the short-circuit signal will be faster.

In summary, the short-circuit protection circuit provided by this embodiment can quickly turn off the power switching transistor when the load side (battery discharge circuit) is short-circuited, preventing damage from thermal breakdown due to sustained overload. Furthermore, the circuit does not require an additional power transistor, resulting in low cost and a simple circuit design. It adopts a hardware protection method with a fast response time and avoids the increased cost of using a multi-channel operational amplifier circuit. This circuit also includes an unlock function controlled by the MCU, allowing for more flexible handling of various post-protection operating conditions, avoiding the drawback of the system being unusable after a false trigger, and providing more flexible judgment on whether the system can be used again after a short circuit, thereby increasing the user's fault tolerance.

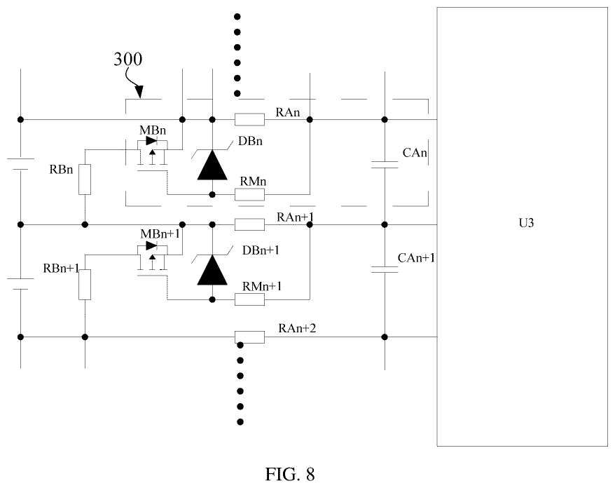

Referring to FIG. 8, FIG. 8 is a topological circuit diagram of a passive balancing circuit for the marine starter battery management system according to an embodiment of the present disclosure.

The passive balancing circuit of an embodiment includes a battery balancing protector U3 and a plurality of balancing-heating multiplexing modules. Each balancing-heating multiplexing module includes a heating film resistor RBn and a balancing-heating control circuit 300. A first terminal and a control terminal of the balancing-heating control circuit 300 are both connected to a positive balancing monitoring terminal of the battery balancing protector U3, which is used for connection to the positive electrode of an individual marine battery cell. A second terminal of the balancing-heating control circuit 300 is connected to a first end of the heating film resistor RBn. A second end of the heating film resistor RBn is connected to a negative balancing monitoring terminal of the battery balancing protector U3, which is used for connection to the negative electrode of the individual marine battery cell. The heating film resistor RBn is disposed within the battery pack formed by the plurality of marine battery cells, such that the heat it generates is used to reduce the internal humidity of the battery pack.

In this embodiment, when the battery balancing protector U3 detects that the voltage difference of an individual marine battery cell exceeds a threshold, the cell initiates balancing protection, turning on an internal balancing switch. This causes the balancing-heating control circuit to transition from an off state to a conductive state, thereby achieving a large balancing current. However, the heating film resistor RBn does not exceed its own power rating and thus avoids problems of severe overheating that would require heat dissipation. The heat generated during the balancing process can be used to reduce the humidity inside the battery pack, lowering the risk of moisture-induced corrosion. In this case, the heat from the heating film resistor RBn performs dehumidification inside the battery pack.

In another embodiment, the heating film resistor RBn is connected to the BMS board of the battery pack and can be placed either on top of or underneath the BMS board.

In one embodiment, referring to FIG. 8, the balancing-heating control circuit 300 includes a balancing-heating electronic switching transistor MBn and a first resistor RAn. A first end of the first resistor RAn is connected to the positive balancing monitoring terminal of the battery balancing protector U3. A second end of the first resistor RAn is connected to a first terminal of the balancing-heating electronic switching transistor MBn. A second terminal of the balancing-heating electronic switching transistor MBn is connected to the first end of the heating film resistor RBn. A control terminal of the balancing-heating electronic switching transistor MBn is connected to the positive balancing monitoring terminal of the battery balancing protector U3. In this embodiment, the switching transistor MBn acts as an on/off switch for the heating film resistor RBn. When the balancing protector U3 detects a voltage difference exceeding the threshold, it turns on its internal balancing switch, and the positive balancing monitoring terminal controls the voltage at the control terminal of the switching transistor MBn, causing it to turn on. This allows the balancing current to dissipate as heat through the heating film resistor RBn. Moreover, this heat is utilized to reduce humidity within the battery pack, lowering corrosion risk and improving the utilization of heat generated during balancing. The first resistor RAn facilitates the rapid turn-on of the switching transistor MBn, thereby improving its switching efficiency.

In another embodiment, during the balancing process, the balancing current includes an external balancing current flowing through the heating film resistor RBn and an internal balancing current flowing through the battery balancing protector U3.

In another embodiment, the heating film resistor RBn is a graphene electrothermal film resistor. By replacing a traditional balancing resistor with a graphene film, the high thermal conductivity and large surface area of graphene can be utilized to rapidly conduct heat to the colder marine battery cells during balancing.

In another embodiment, the heating film resistor RBn is a metal film resistor. By utilizing the high heat capacity of metal, local hotspots can be avoided, and the generated heat can be used to assist in heating the cold marine battery cells.

Further, the balancing-heating control circuit 300 also includes a second resistor RMn. A first end of the second resistor RMn is connected to the first end of the first resistor RAn. A second end of the second resistor RMn is connected to the control terminal of the balancing-heating electronic switching transistor MBn. In this embodiment, the second resistor RMn is in series with the control terminal of the switching transistor MBn to ensure its proper on/off operation.

Still further, the balancing-heating control circuit 300 also includes a balancing Zener diode DBn. A cathode of the balancing Zener diode DBn is connected to the second end of the first resistor RAn, and the cathode is also connected to the second end of the second resistor RMn. In this embodiment, the balancing Zener diode DBn is connected in parallel between the first terminal and the control terminal of the switching transistor MBn to protect the gate of the switching transistor MBn from the effects of transients in the battery pack.

In another embodiment, the balancing-heating electronic switching transistor MBn is a PMOS transistor, wherein the first terminal is the drain, the second terminal is the source, and the control terminal is the gate.

In one embodiment, the balancing-heating control circuit 300 also includes a filter capacitor CAn. A first end of the filter capacitor CAn is connected to the positive balancing monitoring terminal of the battery balancing protector U3, and a second end of the filter capacitor CAn is connected to the negative balancing monitoring terminal. In this embodiment, the filter capacitor CAn is connected in parallel across the two monitoring terminals of the battery balancing protector U3 to filter the voltage of the individual cell being sampled, thereby facilitating timely detection of the voltage difference and improving the precision of the balancing control.

In another embodiment, the plurality of balancing-heating multiplexing modules are connected in series, corresponding to a plurality of marine battery cells that are also connected in series.

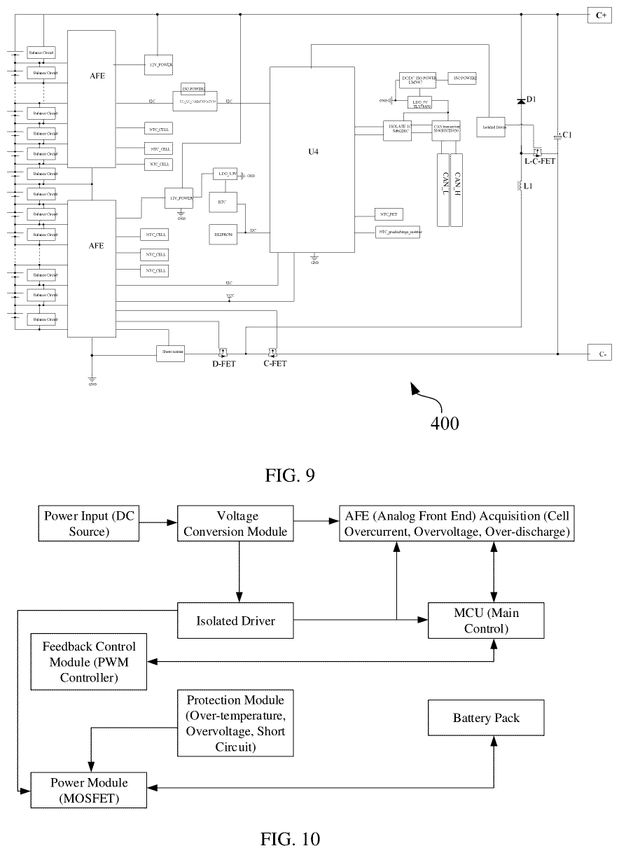

Referring to FIG. 9, FIG. 9 is a circuit diagram of a charging protection circuit for the marine starter battery management system according to an embodiment of the present disclosure.

An embodiment of the marine starter battery management system also includes a charging protection circuit 10, which includes a battery main control module U4, a battery voltage sampling module (AFE), and a charging protection module 400. Sampling terminals of the AFE module are respectively used for monitoring the charging voltage of each marine starter battery cell. The AFE module is in bidirectional communication with the battery main control module U4, enabling the AFE module to output charging protection control signals. The charging protection module 400 includes a charging electronic switching transistor (C-FET), a discharging electronic switching transistor (D-FET), an electrically isolated electronic switching transistor (L-C-FET), and a current-limiting protection inductor L1. A first terminal of the D-FET is connected to a first terminal of the C-FET. A second terminal of the D-FET is connected to ground. A control terminal of the D-FET is connected to a first protection terminal of the AFE module. A control terminal of the C-FET is connected to a second protection terminal of the AFE module. The first terminal of the C-FET is connected to a first end of the current-limiting protection inductor L1. A second end of the inductor L1 is connected to a first terminal of the L-C-FET. A second terminal of the L-C-FET is for connection to the charging positive terminal. A control terminal of the L-C-FET is connected to an isolation control terminal of the battery main control module U4.

In this embodiment, during a charging overcurrent event, the AFE module sends the collected battery voltage to the main control module U4. The main control module U4, as detailed in FIG. 10, sends control signals to turn off the C-FET and turn on the D-FET and the L-C-FET. By controlling the duty cycle of the L-C-FET, the current-limiting protection inductor L1 generates a forward electromotive force, thereby preventing excessive charging current and effectively enhancing the current-limiting protection capability during charging.

In one embodiment, a level-one warning duty cycle for the L-C-FET is between 60% and 80%, specifically 70%. In this embodiment, by adjusting the duty cycle of the L-C-FET during a charging overcurrent event, the magnitude of the current through the inductor L1 can be controlled. The forward electromotive force generated by the inductor L1 limits the charging current to a safe range, thereby achieving precise current-limiting protection.

In another embodiment, when the L-C-FET is turned off, the current in the inductor L1 does not change abruptly, but a reverse electromotive force is generated. To prevent damage from this voltage spike, a freewheeling path is provided. This approach not only limits excessive charging current but also addresses the issue of reduced battery pack lifespan caused by such currents, effectively ensuring charging efficiency.

In another embodiment, the current-limiting protection inductor L1 is an energy storage inductor, specifically an inductor with an iron-silicon-aluminum magnetic core, having an inductance of 22 μH±10%.

In another embodiment, during a level-one charging warning (i.e., charging current>0.9 times the maximum safe charging current for a duration>5 seconds), the duty cycle of the L-C-FET is reduced by 30% to reach 70%, which triggers a CAN bus alarm.

In another embodiment, during a level-two current-limiting warning (i.e., charging current>maximum safe charging current for a duration>2 seconds), the main control module U4 switches the charging mode to a constant voltage mode, limits the current to 0.7 times the maximum current, and initiates active balancing.

In another embodiment, during a level-three power-off warning (i.e., charging current>1.2 times the maximum safe charging current, or an individual cell voltage exceeds its limit), the main control module U4 controls the disconnection of a main relay and activates a backup trickle charging circuit.

In one embodiment, referring to FIG. 9, the charging protection module 400 also includes a pull-up capacitor C1. A first end of the pull-up capacitor C1 is connected to the charging positive terminal. A second end of the pull-up capacitor C1 is connected to the second terminal of the L-C-FET. The second end of the pull-up capacitor C1 is also for connection to the charging negative terminal. In this embodiment, the pull-up capacitor C1 provides a stable quiescent operating point for the L-C-FET.

In another embodiment, the pull-up capacitor C1 is a low-ESR solid-state capacitor with a capacitance of 470 μF.

In one embodiment, referring to FIG. 9, the charging protection module 400 also includes an anti-backflow diode D1. A positive terminal (anode) of the diode D1 is connected to the second end of the inductor L1. A negative terminal (cathode) of the diode D1 is connected to the charging positive terminal. In this embodiment, the diode D1 provides a freewheeling path for the inductor L1, preventing voltage spikes and ensuring the normal current-limiting function of the inductor.

In another embodiment, the anti-backflow diode D1 is a Schottky diode, model W40G120C5, rated for 1200V/40 A.

In one embodiment, the C-FET, D-FET, and L-C-FET are all NMOS transistors, wherein the first terminal is the drain, the second terminal is the source, and the control terminal is the gate.

In another embodiment, the L-C-FET is an NMOS transistor suitable for a DC-DC topology, specifically a BUCK converter, to control its switching frequency and adjust its PWM.

In another embodiment, a PWM generator is used to control the duty cycle of the L-C-FET for application in a DC-DC BUCK circuit.

In one embodiment, the battery main control module U4 is a model STM32G474RET6, a Cortex-M4 with FPU, supporting dual ADC synchronous sampling, used for calculating parameters such as SOC (State of Charge), SOH (State of Health), and SOP (State of Power) from the data collected by the AFE module.

In another embodiment, the battery main control module U4 also samples the charging current via a current sensor. The output of the current sensor is transmitted to the main control module U4 through a magnetic coupling isolator with an isolation voltage rating of 5000Vrms.

In one embodiment, the battery voltage sampling module AFE is a model BQ7693003DBT, used for collecting the health status of the individual marine starter battery cells, such as voltage, current, temperature, and SOC signals.

In another embodiment, the voltage spike suppression circuit is of the prior art, as detailed in patent application No. CN202410876783.3.

The above embodiments merely express several implementations of the present disclosure. Their description is relatively specific and detailed, but they should not be construed as a limitation on the scope of the disclosed patent. It should be pointed out that for a person of ordinary skill in the art, several variations and improvements can be made without departing from the concept of the present disclosure, and these all fall within the protection scope of the present disclosure. Therefore, the protection scope of the patent of the present disclosure should be subject to the appended claims.

1. A marine starter battery management system, comprising:
a battery management unit configured to acquire battery state parameters of a battery unit, the battery unit comprising a plurality of individual cells;
a heating circuit configured to heat the battery unit in a low-temperature environment, wherein an output power of the heating circuit is between 50 W and 500 W;
a high-current charging and discharging drive circuit configured to drive the battery unit for high-current charging and discharging under low-temperature and low-voltage conditions;
a passive balancing circuit configured to dissipate energy from individual cells with higher voltages within the battery unit to balance a voltage of each of the plurality of individual cells, the passive balancing circuit comprising a plurality of heating resistors;
a voltage spike suppression circuit configured to suppress voltage spikes at an end of a charging cycle, the voltage spike suppression circuit comprising a plurality of clamping diodes;
a soft-start circuit configured to limit a current rise rate during startup of the battery unit; and
a processing unit electrically connected to the battery management unit, the heating circuit, the high-current charging and discharging drive circuit, the passive balancing circuit, the voltage spike suppression circuit, and the soft-start circuit, the processing unit being configured to, based on the battery state parameters, control in real-time operating states and operating sequences of the heating circuit, the high-current charging and discharging drive circuit, the passive balancing circuit, the voltage spike suppression circuit, and the soft-start circuit.

2. The marine starter battery management system of claim 1, wherein the heating circuit comprises at least one heating sheet attached to or adjacent to the battery unit; and
wherein a balancing current of the passive balancing circuit is between 0.5 A and 10 A, and a power of the plurality of heating resistors is between 3 W and 30 W.

3. The marine starter battery management system of claim 1, wherein a clamping voltage of the plurality of clamping diodes is between 110% and 125% of a rated voltage of the battery unit.

4. The marine starter battery management system of claim 1, wherein the high-current charging and discharging drive circuit comprises:
a power switching transistor configured to control a connection and a disconnection of a main power circuit, the main power circuit being a current path between the battery unit and a load, wherein a rated current of the power switching transistor is not less than 80 A; and
a driver configured to drive the power switching transistor, the driver being electrically connected to the processing unit and the power switching transistor;
wherein the processing unit is configured to control an operating state of the driver based on a temperature parameter and a voltage parameter of the battery unit.

5. The marine starter battery management system of claim 1, wherein the passive balancing circuit comprises:
a comparator array configured to compare the voltage of each of the plurality of individual cells, the comparator array being electrically connected to each of the plurality of individual cells;
a switch array configured to select an individual cell requiring balancing, the switch array being electrically connected to the comparator array; and
a resistor array configured to dissipate the energy from the individual cells with higher voltages, the resistor array comprising the plurality of heating resistors, wherein the resistor array is selectively connected in parallel with any of the plurality of individual cells via the switch array.

6. The marine starter battery management system of claim 1, further comprising:
a power supply module configured to provide operating power to the processing unit, the battery management unit, the heating circuit, the high-current charging and discharging drive circuit, the passive balancing circuit, the voltage spike suppression circuit, and the soft-start circuit;
a MOS short-circuit detection module configured to detect a short-circuit state of a power switching transistor in a main power circuit, the main power circuit being a current path between the battery unit and a load; and
a low-power sleep module configured to cause the system to enter a sleep state when the battery unit is not in use for an extended period to reduce static power consumption;
wherein the processing unit is further electrically connected to the power supply module, the MOS short-circuit detection module, and the low-power sleep module.

7. The marine starter battery management system of claim 1, further comprising a communication interface circuit and a display module, wherein the communication interface circuit comprises a Bluetooth chip and a communication module for implementing wireless and wired data transmission, and wherein the communication module is a UART port, an RS485 bus, or a CAN bus;
wherein the display module is configured to display an operating status of the battery and is an LED indicator circuit or an LCD display circuit;
wherein the processing unit is further electrically connected to the communication interface circuit and the display module; and
wherein the Bluetooth chip is configured to transmit the battery state parameters, and the processing unit is configured to send diagnostic information and abnormal alert data to an external device via the Bluetooth chip, the battery state parameters comprising a voltage parameter, a current parameter, a temperature parameter, an SOC parameter, and an SOH parameter.

8. The marine starter battery management system of claim 7, wherein the Bluetooth chip is configured to transmit the battery state parameters, and the processing unit is configured to send diagnostic information and abnormal alert data to an external device via the Bluetooth chip, the battery state parameters comprising the voltage parameter, the current parameter, the temperature parameter, the SOC parameter, and the SOH parameter.

9. The marine starter battery management system of claim 8, wherein:
when a temperature parameter of the battery unit is below a first preset threshold, the processing unit controls the heating circuit to activate and pauses a high-current charge and discharge operation;
when a detected voltage difference between the plurality of individual cells exceeds a second preset threshold, the processing unit initiates a passive balancing control; and
when a charging current drops to a third preset threshold, the processing unit initiates a voltage spike suppression control;
wherein the first preset threshold is between −10° C. and 5° C., the second preset threshold is between 30 mV and 100 mV, and the third preset threshold is between 5% and 15% of a rated charging current;
and/or, wherein during a period when the heating circuit is activated, the passive balancing control is stopped.

10. The marine starter battery management system of claim 1, further comprising a short-circuit protection circuit configured to immediately disconnect a battery discharge circuit when a short circuit occurs therein, the short-circuit protection circuit comprising a self-latching module;
wherein the self-latching module comprises a short-circuit signal latching unit having a switching transistor K1, a short-circuit response unit having a switching transistor K2, and a circuit turn-off unit having a switching transistor K3; wherein an output of the short-circuit response unit is electrically connected to an input of the circuit turn-off unit and an input of the short-circuit signal latching unit, respectively; an output of the circuit turn-off unit is electrically connected to a control terminal of a power control switching transistor; and an output of the short-circuit signal latching unit is electrically connected to an input of the short-circuit response unit;
wherein when the battery discharge circuit is operating normally, the switching transistors K1, K2, and K3 are non-conductive; and when the short circuit occurs, a low-level signal is applied to the input of the short-circuit response unit, causing the switching transistor K2 to become conductive and the output of the short-circuit response unit to output a high-level signal; and upon the high-level signal being applied to the input of the short-circuit signal latching unit, the switching transistor K1 becomes conductive, causing the output of the short-circuit signal latching unit to be pulled down to a low-level signal, thereby locking a state of the switching transistor K2 to be conductive; and upon the high-level signal being applied to the input of the circuit turn-off unit, the switching transistor K3 becomes conductive, pulling the control terminal of the power control switching transistor down to a low-level signal and causing the power control switching transistor to become non-conductive; and
wherein the self-latching module is further electrically connected to an unlock module, the unlock module being configured to be controlled, after the short circuit occurs, to pull the input of the short-circuit signal latching unit down to a low-level signal to cause the switching transistor K1 to become non-conductive.

11. The marine starter battery management system of claim 1, wherein the passive balancing circuit comprises a battery balancing protector and a plurality of balancing-heating multiplexing modules;
wherein each of the plurality of balancing-heating multiplexing modules comprises a heating film resistor and a balancing-heating control circuit; a first terminal and a control terminal of the balancing-heating control circuit are both connected to a positive balancing monitoring terminal of the battery balancing protector, the positive balancing monitoring terminal being configured for connection to a positive electrode of an individual marine starter battery cell; a second terminal of the balancing-heating control circuit is connected to a first end of the heating film resistor; a second end of the heating film resistor is connected to a negative balancing monitoring terminal of the battery balancing protector, the negative balancing monitoring terminal being configured for connection to a negative electrode of the individual marine starter battery cell; and wherein the heating film resistor is disposed within a battery pack formed by the plurality of individual marine starter battery cells such that heat generated by the heating film resistor is used to reduce humidity inside the battery pack.

12. The marine starter battery management system of claim 1, further comprising a charging protection circuit, the charging protection circuit comprising:
a battery main control module;
a battery voltage sampling module, wherein sampling terminals of the battery voltage sampling module are respectively configured for connection with a charging voltage of each of the plurality of individual marine starter battery cells, and the battery voltage sampling module is in bidirectional communication with the battery main control module to enable the battery voltage sampling module to output a charging protection control signal; and
a charging protection module comprising a charging electronic switching transistor, a discharging electronic switching transistor, an electrically isolated electronic switching transistor, and a current-limiting protection inductor; wherein a first terminal of the discharging electronic switching transistor is connected to a first terminal of the charging electronic switching transistor; a second terminal of the discharging electronic switching transistor is connected to ground; a control terminal of the discharging electronic switching transistor is connected to a first protection terminal of the battery voltage sampling module; a control terminal of the charging electronic switching transistor is connected to a second protection terminal of the battery voltage sampling module; the first terminal of the charging electronic switching transistor is connected to a first end of the current-limiting protection inductor; a second end of the current-limiting protection inductor is connected to a first terminal of the electrically isolated electronic switching transistor; a second terminal of the electrically isolated electronic switching transistor is configured for connection to a charging positive terminal; and
a control terminal of the electrically isolated electronic switching transistor is connected to an isolation control terminal of the battery main control module.

13. A method for monitoring low-temperature charging and discharging of a marine starter battery, applied to the marine starter battery management system of any one of claims 1 to 12, the method comprising:
acquiring a charge and discharge temperature of the battery unit;
performing a likelihood loss process on the charge and discharge temperature and a preset battery temperature to obtain a charge and discharge temperature loss value;
determining whether the charge and discharge temperature loss value matches a preset temperature loss value; and
when the charge and discharge temperature loss value matches the preset temperature loss value, sending a low-temperature heating adjustment signal to a heating controller to adjust a power output mode of the heating circuit.

14. The method of claim 13, wherein determining whether the charge and discharge temperature loss value matches the preset temperature loss value comprises:
determining whether the charge and discharge temperature loss value is less than a first temperature loss value and greater than a second temperature loss value, wherein the preset battery temperature is a temperature range between a first preset temperature and a second preset temperature, the first temperature loss value corresponds to the first preset temperature, the second temperature loss value corresponds to the second preset temperature, and the first preset temperature is greater than the second preset temperature.

15. The method of claim 14, wherein when the charge and discharge temperature loss value is less than the first temperature loss value and greater than the second temperature loss value, sending a low-temperature heating enable signal comprises:
determining whether the charge and discharge temperature loss value is less than a critical temperature loss value, wherein the critical temperature loss value corresponds to a third preset temperature, and the third preset temperature is less than the first preset temperature and greater than the second preset temperature; and
when the charge and discharge temperature loss value is less than the critical temperature loss value, sending a low-temperature full-power output signal to the heating controller to cause the heating circuit to operate at a full power output.

16. The method of claim 15, further comprising:
when the charge and discharge temperature loss value is greater than or equal to the critical temperature loss value, sending a low-temperature reduced-power output signal to the heating controller to cause the heating circuit to operate at a low-power output.

17. The method of claim 15, wherein after sending the low-temperature full-power output signal to cause the heating circuit to operate at the full power output, the method further comprises:
acquiring a battery pack charging voltage of the battery unit;
determining whether the battery pack charging voltage is greater than a first preset charging voltage; and
when the battery pack charging voltage is greater than the first preset charging voltage, sending a level-one charging clamping signal to a spike suppression controller to cause M1 clamping diodes of the voltage spike suppression circuit to be enabled, wherein M1 is a positive integer and M1<10.

18. The method of claim 17, further comprising:
when the battery pack charging voltage is less than or equal to the first preset charging voltage, determining whether the battery pack charging voltage is greater than a second preset charging voltage, wherein the second preset charging voltage is less than the first preset charging voltage; and
when the battery pack charging voltage is greater than the second preset charging voltage, sending a level-two charging clamping signal to the spike suppression controller to cause M2 clamping diodes of the voltage spike suppression circuit to be enabled, wherein M2 is a positive integer and M1<M2<10.

19. The method of claim 18, further comprising:
when the battery pack charging voltage is less than or equal to the second preset charging voltage, determining whether the battery pack charging voltage is greater than a third preset charging voltage, wherein the third preset charging voltage is less than the second preset charging voltage; and
when the battery pack charging voltage is greater than the third preset charging voltage, sending a level-three charging clamping signal to the spike suppression controller to cause M3 clamping diodes of the voltage spike suppression circuit to be enabled, wherein M3 is a positive integer and M2<M3<10.

20. The method of claim 19, further comprising:
when the battery pack charging voltage is less than or equal to the third preset charging voltage, sending a fourth-level charging clamping signal to the spike suppression controller to cause M4 clamping diodes of the voltage spike suppression circuit to be enabled, wherein M4 is a positive integer and M3<M4<10.
